(19) United States
(12) Patent Application Publication
(10) Pub. No.: US 2013/0073196 A1
(43) Pub. Date: Mar. 21, 2013

(54) GENERATION OF MACHINE READABLE CODES BY A NAVIGATION SYSTEM THAT INDICATES INFORMATION TO A MOBILE DEVICE

(71) Applicants: Suzann Hua, Lisle, IL (US); Ahmed N. Zaki, Lisle, IL (US)

(72) Inventors: Suzann Hua, Lisle, IL (US); Ahmed N. Zaki, Lisle, IL (US)

(21) Appl. No.: 13/236,350

(22) Filed: Sep. 19, 2011

(51) Int. Cl. G01C 21/00

(52) U.S. Cl. 701/409

(57) ABSTRACT

Systems and methods are disclosed for generating machine readable codes by a navigation system that indicates information for a point of interest on a map. In one embodiment, a system includes a controller, a GPS receiver, and a user interface. The GPS receiver identifies location data. The user interface displays a map based on the location data, displays a plurality of points of interest on the map, and receives a selection of one of the plurality of points of interest from a user. The controller identifies information for a selected point of interest, generates a machine readable code that indicates the information for the selection, and provides the machine readable code to the user interface for capture by a mobile device.

### FIELD OF THE INVENTION

The invention is related to the field of communication systems.

### BACKGROUND

The Global Positioning System (GPS) is a satellite-based global navigation system that provides location and time information anywhere on Earth using GPS satellites. A GPS receiver calculates its current location by precisely timing the signals sent by the GPS satellites in view of the receiver. Each of the GPS satellites transmits messages that include the time a message was sent, the orbital information of the satellite, and a rough orbit of all of the GPS satellites. The receiver analyzes the messages to compute a distance to the GPS satellites in view, and determines a current location of the receiver.

GPS navigation systems typically display a map, a current location of the navigation system, and various points of interest that the user may navigate to. Such points of interest may include cities, hotels, restaurants, gas stations, etc. Using the navigation system, the user may select a point of interest (e.g., using a touch screen or some other user interface) and be provided directions on navigating to the point of interest. While basic location information about a point of interest is available to the user, such systems lack the ability to provide additional information and capabilities to the user.

### SUMMARY

Embodiments described herein allow for the utilization of information for a point of interest by mobile devices using machine readable codes, such as Quick Response (QR) codes. One example of information for a point of interest includes an Internet website. In the example, a navigation system generates a machine readable code that indicates a website for a point of interest. A mobile device that has access to the Internet (e.g., via a mobile network) captures the machine readable code and allows the user to browse to the website for the point of interest. This provides the user of the navigation system additional information and capabilities.

One embodiment is a system comprising a Global Positioning System (GPS) receiver, a user interface, and a controller. The GPS receiver can identify location data. The user interface displays a map based on the location data, displays a plurality of points of interest on the map, and receives a selection of one of the plurality of points of interest from a user. The controller identifies information for a selected one of the plurality of points of interest, and generates a machine readable code that indicates the information. The controller then provides the machine readable code to the user interface for capture by a mobile device.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a GPS navigation system in an exemplary embodiment.

FIG. 2 is a flow chart illustrating a method of generating a machine readable code that indicates information for a point of interest in an exemplary embodiment.

FIG. 3 is an example of user interface and a map in an exemplary embodiment.

FIG. 4 is an example of user interface and map after a selection of a point of interest in an exemplary embodiment.

FIG. 5 is an example of a machine readable code in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

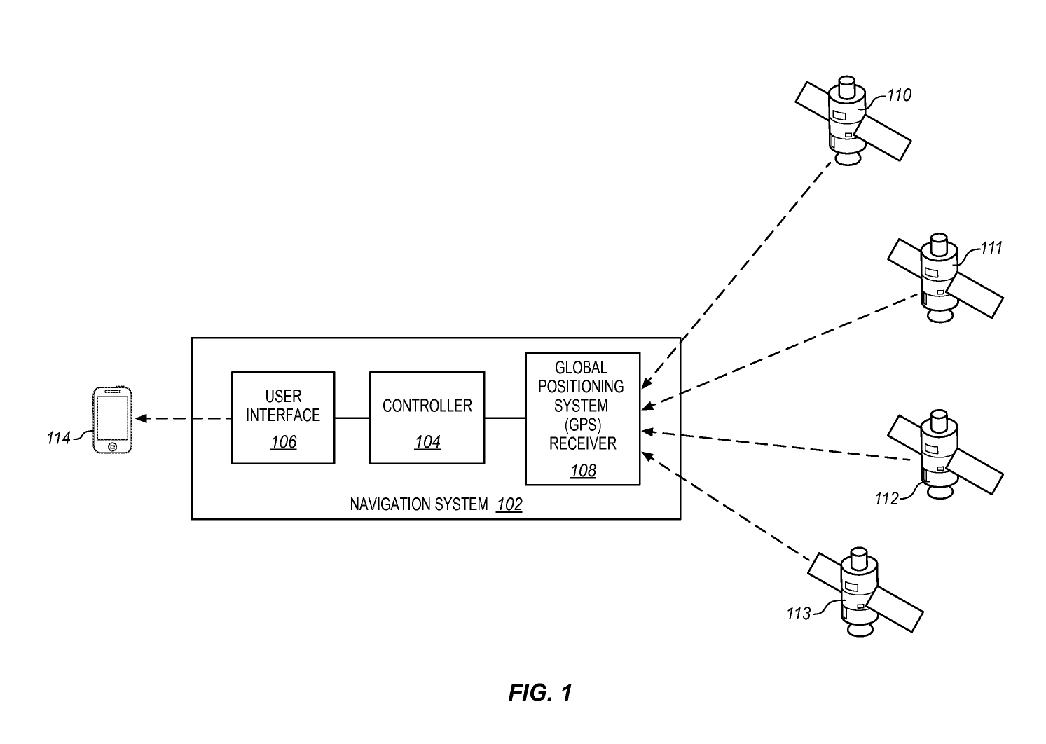

FIG. 1 illustrates a GPS navigation system 102 in an exemplary embodiment. Navigation system 102 receives radio broadcasts from one or more satellites 110-113 in Earth orbit to calculate a location of navigation system 102. For example, navigation system 102 may be a GPS based system that is installed in an automobile, a stand-alone GPS navigation system, a navigation module on a mobile device, etc. Navigation system 102 allows a user to navigate to a point of interest (e.g., a hotel, a restaurant, a gas station, a movie theater, etc.). In this embodiment, navigation system 102 displays navigation maps based on location data received by one or more satellites 110-113, and provides navigation information to the user for a point of interest. In this embodiment, navigation system 102 does not have the capabilities and/or access to a mobile network to make telephone calls, and/or reach Internet resources. Thus, navigation system 102 does not directly make calls or browse the Internet for websites. However, information for a point of interest is desirable to the user. For example, the user may wish to call a restaurant to make a reservation, may wish to look at a menu for the restaurant, may wish to review a hiking trail map for a park, etc.

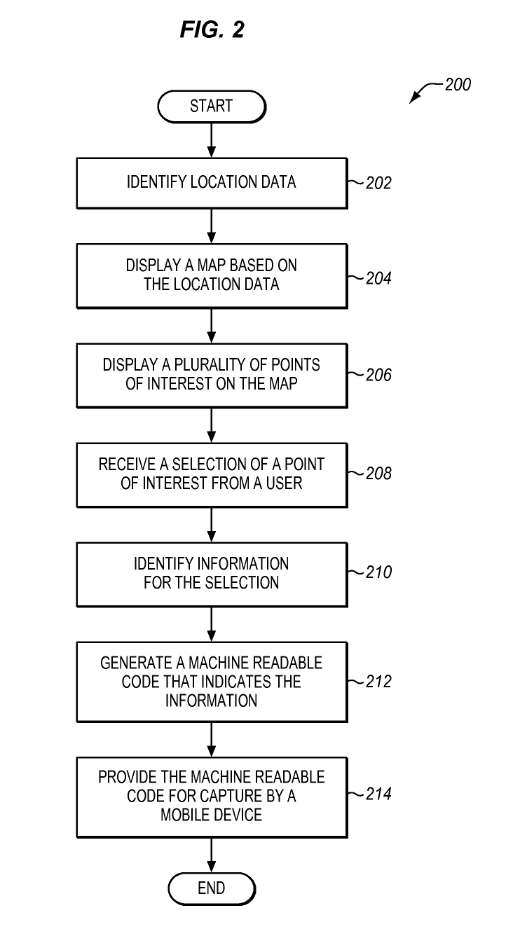

To provide these capabilities to the user, navigation system 102 generates a machine readable code that indicates the information for the point of interest. The navigation system 102 then displays the machine readable code for capture by a mobile device 114. Mobile device, which may be a smart phone, a tablet computer, or some other network-enabled device, may then decode and access a network to place a call, browse to an Internet website, display a hiking trail map for a park, etc. How navigation system 102 may operate will be discussed in more detail with regard to FIG. 2.

FIG. 2 is a flow chart illustrating a method 200 of generating a machine readable code that indicates information for a point of interest in an exemplary embodiment. The steps of method 200 will be described with respect to navigation system 102 of FIG. 1, although one skilled in the art will understand that method 200 may be performed by other systems not shown. The steps of method 200 are not all inclusive and may include other steps not shown. The steps may also be performed in an alternative order.

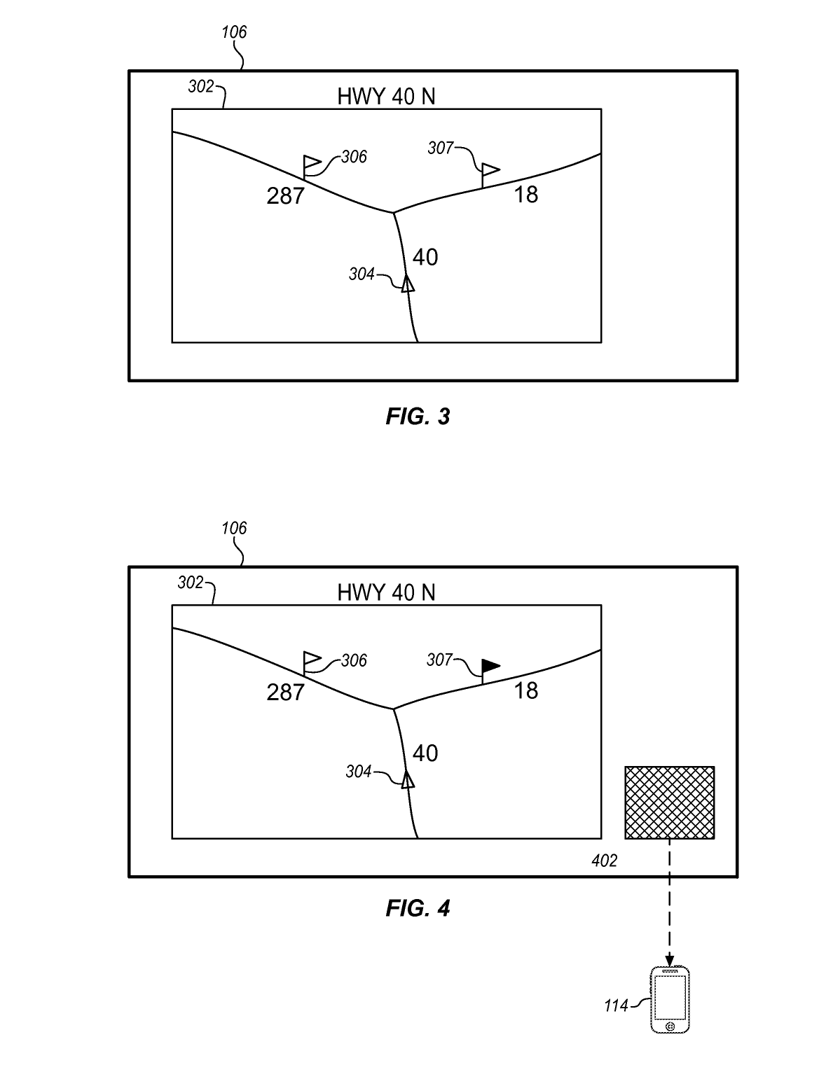

In step 202, GPS receiver 108 identifies location data from one or more satellites 110-113. In step 204, user interface 106 displays a map based on the location data. FIG. 3 is an example of user interface 106 and a map 302 in an exemplary embodiment. Map 302 may include an icon 304 indicating a location of navigation system 102 based on the location data. In step 206 (see FIG. 2), user interface 106 displays a plurality of points of interest 306-307 (see FIG. 3). Points of interest 306-307 may include hotels, restaurants, gas stations, movie theaters, places of business, etc. Points of interest 306-307 may be an active navigation destination selected by the user, or merely a possible location that the user may desire contact information for. Although only two points of interest 306-307 are shown on map 302, one skilled in the art will understand that any number of points of interest may be displayed on map 302 and/or selected by the user.

In step 208, user interface 106 receives a selection of one of the plurality of points of interest from the user. FIG. 4 is an example of user interface 106 and map 302 after a selection of point of interest 307 in an exemplary embodiment. The selection of point of interest 307 is illustrated by a change in the icon used to represent point of interest 307. A user may select point of interest 307 using a variety of input methods for user interface 106, such as touch interfaces, a mouse interface, voice commands, etc.

In step 210, controller 104 identifies information for the selected point of interest 307. The information may be stored in a database of navigation system 102, a local memory of navigation system 102, on a Compact Disk (CD) or Digital Versatile Disk (DVD), a memory card, or some other type of storage device accessible by navigation system 102. The information may include a telephone number for the point of interest, an Internet resource for the point of interest, a menu, a hiking map of a trail, etc. Generally, the information for a point of interest may be any type of information that a user may wish to review on a mobile device. Internet resources may include web pages and files available for download from the Internet. In this embodiment, the information indicates a network resource that navigation system 102 does not have access to. For example, if navigation system 102 does not have access to the Internet, then the information may be a Hypertext Transfer Protocol (HTTP) link to a website for the point of interest. In continuing with the example, if navigation system 102 does not have access to a telephone network, then the information may be a phone number for the point of interest.

In step 212, controller 104 generates a machine readable code 402 that indicates the information for the point of interest selected by the user. Machine readable code 402 may be a 2-dimensional bar code, a Quick Response code, or some other type of graphical matrix barcode that is used to represent encoded data. In step 214, controller 104 provides the machine readable code 402 to user interface 106 for capture by mobile device 114.

Mobile device 114 may then capture the machine readable code 402 (e.g., the user may take a picture of machine readable code 402 using mobile device 114), decode machine readable code 402, and access a network to utilize the information. For example, mobile device 114 may decode machine readable code 402 to identify a telephone number for point of interest 307. Using a mobile network, mobile device 114 may then place a call to the telephone number for point of interest 307. In continuing with the example, mobile device 114 may also decode machine readable code 402 to identify a website for point of interest 307. Using a mobile network, mobile device 114 may then use a web browser to display the website for point of interest 307. This allows the user to utilize the information for a point of interest even though navigation system 102 does not have access to network resources, such as a mobile network. Mobile device 114 may also decode machine readable code 402 to identify additional information about the point of interest selected by the user. For example, machine readable code 402 may encode a trail map for a park, a menu for a restaurant, historical data about a point of interest, etc. Generally, any data that may be encoded by machine readable code 402 is available for capture by mobile device 114.

### EXAMPLE

In the following example, consider that a user is driving in an automobile that includes navigation system 102 (see FIG. 1), and that the user desires to locate a restaurant (i.e., a point of interest) nearby for lunch. During the drive, navigation system 102 identifies location data from one or more satellites 110-113. The location data is used by navigation system 102 to place an icon on a map that identifies to the user the current location of the vehicle.

As the current location of navigation system 102 changes during the drive, navigation system 102 displays updates to the current location by re-positioning an icon on the map. Using navigation system 102, the user may perform a search of restaurants that may be nearby, may be along a projected navigation route, and/or may be proximate to a destination. Based on the search, navigation system 102 displays a plurality of restaurants on the map. The user may then select one of the restaurants on the map for more information.

Based on the selection, navigation system 102 identifies contact information for the selected restaurant. The contact information may be a phone number for the restaurant, a website for the restaurant, a Uniform Resource Locator (URL) for the restaurant, etc. In the example, the contact information is a website for the restaurant. Navigation system 102 then encodes the website information (e.g., an http://address) into a machine readable code, and displays the machine readable code to the user for capture by mobile device 114.

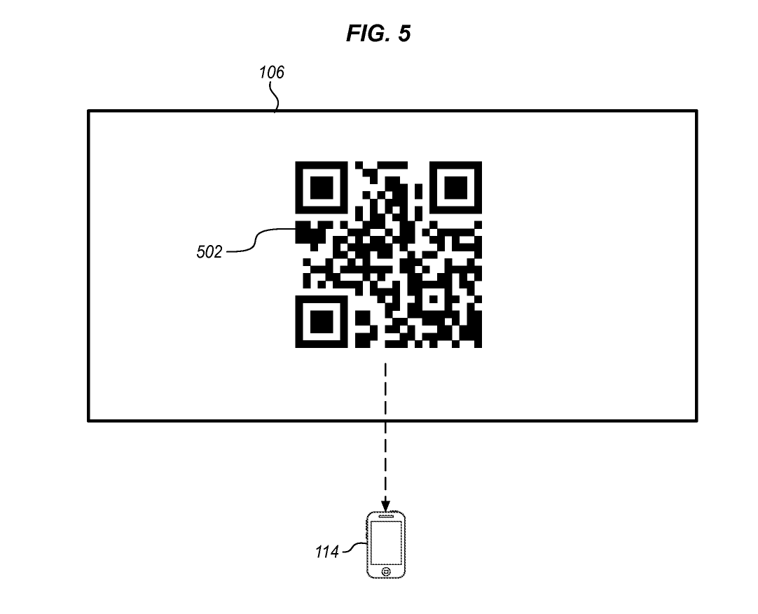

FIG. 5 is an example of a machine readable code in an exemplary embodiment. In FIG. 5, the machine readable code is a QR code 502. In the example, QR code 502 encodes a website for the restaurant. The user may then capture QR code 502 using a camera on mobile device 114, decode QR code 502, and access a mobile network to browse to the website encoded by QR code 502.

In some cases, the contact information indicated in QR code 502 may indicate the current location of the user and/or the location of the point of interest. This may allow the user to park the automobile and continue to travel to the point of interest by navigating on a map displayed on mobile device 114. Because QR code 502 may include location information for the current location and/or the location of the point of interest, the user may easily navigate through an area that is not accessible to the automobile, such as a large shopping mall, using mobile device 114.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are functional when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a controller;
a Global Positioning System (GPS) receiver configured to identify location data; and
a user interface configured to display a map based on the location data, to display a plurality of points of interest on the map, and to receive a selection of one of the plurality of points of interest from a user;
the controller is further configured to identify information for a selected one of the plurality of points of interest, to generate a machine readable code that indicates the information for the selected one of the plurality of points of interest, and to provide the machine readable code to the user interface for capture by a mobile device.

2. The system of claim 1 wherein:
the information identified is contact information for the selected one of the plurality of points of interest.

3. The system of claim 2 wherein:
the contact information indicates at least one of a telephone number and an Internet website for the point of interest.

4. The system of claim 1 wherein:
the machine readable code is a 2-dimensional bar code.

5. The system of claim 1 wherein:
the machine readable code is a Quick Response (QR) code.

6. The system of claim 1 wherein:
the control system does not have the capability to access a mobile network to utilize the information.

7. The system of claim 1 wherein:
the control system is further configured to identify a current location based on the location data, to identify a target location of the point of interest, and to generate the machine readable code to indicate the current location and the target location for capture by the mobile device to allow the user to navigate to the point of interest using the mobile device.

8. A method operable on a navigation system, the method comprising:
identifying location data for a Global Positioning System (GPS);
displaying a map based on the location data;
displaying a plurality of points of interest on the map;
receiving a selection of one of the plurality of points of interest from a user;
identifying information for a selected one of the plurality of points of interest;
generating a machine readable code that indicates the information for the selected one of the plurality of points of interest; and
providing the machine readable code to the user for capture by a mobile device.

9. The method of claim 8 wherein:
the information is contact information for the selected one of the plurality of points of interest.

10. The method of claim 9 wherein:
the contact information indicates at least one of a telephone number and an Internet website for the point of interest.

11. The method of claim 8 wherein:
the machine readable code is a 2-dimensional bar code.

12. The method of claim 8 wherein:
the machine readable code is a Quick Response (QR) code.

13. The method of claim 8 wherein:
the navigation system does not have the capability to access a mobile network to utilize the information.

14. The method of claim 8 further comprising:
identifying a current location based on the location data;
identifying a target location of the point of interest; and
generating the machine readable code to indicate the current location and the target location for capture by the mobile device to allow the user to navigate to the point of interest using the mobile device.

15. A tangible computer readable medium embodying programmed instructions which, when executed on a processor of a navigation system, are operable for performing a method, the method comprising:
identifying location data for a Global Positioning System (GPS);
displaying a map based on the location data;
displaying a plurality of points of interest on the map;
receiving a selection of one of the plurality of points of interest from a user;
identifying information for a selected one of the plurality of points of interest;
generating a machine readable code that indicates the information for the selected one of the plurality of points of interest; and
providing the machine readable code to the user for capture by a mobile device.

16. The medium of claim 15 wherein:
the information is contact information for the selected one of the plurality of points of interest.

17. The medium of claim 16 wherein:
the contact information indicates at least one of a telephone number and an Internet website for the point of interest.

18. The medium of claim 15 wherein:
the machine readable code is a 2-dimensional bar code.

19. The medium of claim 15 wherein:
the machine readable code is a Quick Response (QR) code.

20. The medium of claim 15 wherein:
the navigation system does not have the capability to access a mobile network to utilize the information.

21. The medium of claim 15 further comprising:
identifying a current location based on the location data;
identifying a target location of the point of interest; and
generating the machine readable code to indicate the current location and the target location for capture by the mobile device to allow the user to navigate to the point of interest using the mobile device.
